(19) United States
(12) Patent Application Publication
(10) Pub. No.: US 2011/0043349 A1
(43) Pub. Date: Feb. 24, 2011

(54) Active Wide-band Air Fuel Ratio Indicator

(76) Inventor: Lawrence Antony Johnson, Pflugerville, TX (US)

Correspondence Address: JOHN MARTIN TABOADA, 1923 N. NEW BRAUNFELS, SAN ANTONIO, TX, 78208, US

(21) Appl. No.: 12/861,992

(22) Filed: Aug. 24, 2010

Related U.S. Application Data
(60) Provisional application No. 61/236,439, filed on Aug. 24, 2009.
(60) Provisional application No. 61/257,549, filed on Nov. 3, 2009.

(51) Int. Cl. B60Q 1/00

(52) U.S. Cl. 340/439

(57) ABSTRACT

Methods and systems for protecting an engine of a vehicle are disclosed, including reading a throttle position voltage, an engine RPM voltage, and a voltage from an air fuel ratio (AFR) system comprising a wide-band oxygen sensor; converting the voltage from the AFR system to an AFR value; determining whether the throttle position voltage exceeds a preset threshold throttle position voltage; in response to determining that the throttle position voltage exceeds the preset threshold throttle position voltage, determining whether the AFR value exceeds a preset safe lower AFR limit or a preset safe upper AFR limit and whether the engine RPM voltage exceeds a preset threshold RPM voltage; in response to determining that the AFR value exceeds the preset safe lower AFR limit or the preset safe upper AFR limit and the engine RPM voltage exceeds the preset threshold RPM voltage, turning on a visual indicator, turning on an audible indicator, and/or triggering an active component. Other embodiments are described and claimed.

### I. CROSS REFERENCE TO RELATED APPLICATIONS

The inventor claims priority to provisional patent application number 61/236,439 filed on Aug. 24, 2009 and to provisional patent application No. 61/257,549 filed on Nov. 3, 2009.

### II. BACKGROUND

The invention relates generally to the field of monitoring automotive system parameters. More specifically, the invention relates to the active monitoring of the air fuel ratio of a combustion engine.

### III. SUMMARY

In one respect, disclosed is a method for protecting an engine of a vehicle, the method comprising: reading a throttle position voltage, an engine RPM voltage, and a voltage from an air fuel ratio (AFR) system comprising a wide-band oxygen sensor; converting the voltage from the AFR system to an AFR value; determining whether the throttle position voltage exceeds a preset threshold throttle position voltage; in response to determining that the throttle position voltage exceeds the preset threshold throttle position voltage, determining whether the AFR value exceeds a preset safe lower AFR limit or a preset safe upper AFR limit and whether the engine RPM voltage exceeds a preset threshold RPM voltage; in response to determining that the AFR value exceeds the preset safe lower AFR limit or the preset safe upper AFR limit and the engine RPM voltage exceeds the preset threshold RPM voltage, turning on a visual indicator, turning on an audible indicator, and/or triggering an active component.

In another respect, disclosed is an apparatus for protecting an engine of a vehicle, the apparatus comprising: one or more processors; one or more memory units coupled to the one or more processors; and a visual indicator coupled to the one or more processors; the apparatus being configured to: read a throttle position voltage, an engine RPM voltage, and a voltage from an air fuel ratio (AFR) system comprising a wide-band oxygen sensor; convert the voltage from the AFR system to an AFR value; determine whether the throttle position voltage exceeds a preset threshold throttle position voltage; in response to determining that the throttle position voltage exceeds the preset threshold throttle position voltage, determine whether the AFR value exceeds a preset safe lower AFR limit or a preset safe upper AFR limit and whether the engine RPM voltage exceeds a preset threshold RPM voltage; in response to determining that the AFR value exceeds the preset safe lower AFR limit or the preset safe upper AFR limit and the engine RPM voltage exceeds the preset threshold RPM voltage, turn on a visual indicator, turn on an audible indicator, and/or trigger an active component.

Numerous additional embodiments are also possible.

### IV. BRIEF DESCRIPTION OF THE DRAWINGS

Other objects and advantages of the invention may become apparent upon reading the detailed description and upon reference to the accompanying drawings.

FIG. 1 is a block diagram of an active wide-band air fuel ratio indicator system, in accordance with some embodiments.

FIG. 2 is a flow diagram illustrating a method for actively monitoring an air fuel ratio, in accordance with some embodiments.

FIG. 3 is a graphical user interface for the air fuel ratio indicator, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### V. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

The air fuel ratio, known as “AFR”, is the ratio of the air to the fuel in a combustion engine. This ratio is measured at the output of the engine block as the emissions from combustion chambers are delivered to the exhaust system. The AFR is vital to the health of high performance sports cars. By properly managing and monitoring the AFR, the longevity of expensive modified engines may be promoted. Current AFR gauge systems continuously display the wide-band air fuel ratio measured by the oxygen sensor and lack any active measures to correct any undesirable AFR situations. Additionally, since current AFR gauge systems continuously display the AFR, they do not have any audible indicators because if they did, they would be continuously sounding during situations that were not critical to engine performance, as during idle.

The embodiment or embodiments described herein may solve these problems as well as others by proposing an active wide-band air fuel ratio indicator based on selectively engaging the AFR data.

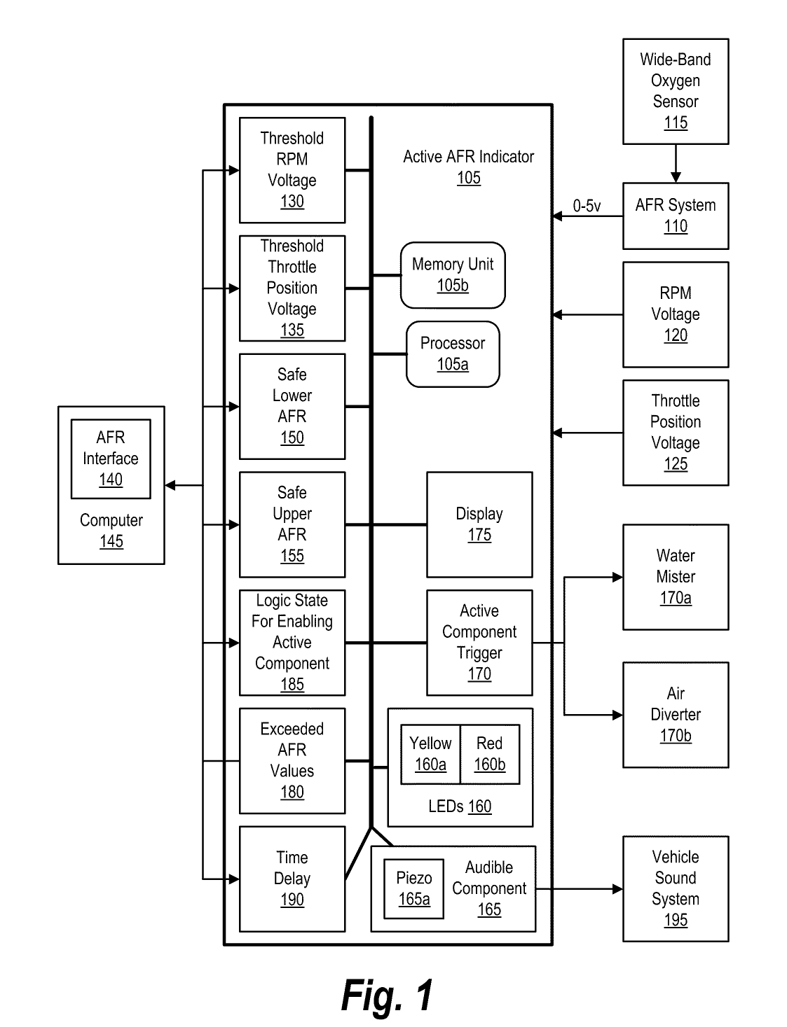

FIG. 1 is a block diagram of an active wide-band air fuel ratio indicator system, in accordance with some embodiments.

In some embodiments, an active wide-band air fuel ratio indicator 105 comprises a processor 105a, a memory unit 105b, a display 175, LEDs 160 (or any other visual indicators such as lamps or light guides), and an audible component 165, all of which are directly or indirectly coupled to each other. Processor 105a is configured to perform computations and general control operations and memory unit 105b is configured to store data using non-volatile memory, volatile memory, or both. The active wide-band air fuel ratio indicator 105 is electrically powered by a vehicle. The power from the vehicle is sent to a regulator to maintain a nine or twelve volt DC voltage that is sent to a precision voltage reference. The precision voltage reference sends five volts DC to the microprocessor of the active wide-band air fuel ratio indicator 105 which uses the voltage for power and also as a reference for an on board voltage comparator. The active wide-band air fuel ratio indicator 105 is configured to read and process with the on board voltage comparator, the voltage from an air fuel ratio system 110 that provides a zero to five volt analog output signal. The air fuel ratio system 110 reads a wide-band oxygen sensor 115 mounted in an engine's exhaust. Instead of continuously displaying the wide-band air fuel ratio measured by the wide-band oxygen sensor 115 and continuously alerting the driver of a potential problem, the active wide-band air fuel ratio indicator 105 provides critical information regarding the air fuel ratio of an engine's exhaust only when certain parameters are met. The active wide-band air fuel ratio indicator 105 is further configured to read the engine RPM voltage 120 and the throttle position voltage 125. The active wide-band air fuel ratio indicator 105 has stored preset voltage values for the threshold engine RPM voltage 130 as well as the threshold throttle position voltage 135. The threshold engine voltage RPM 130 as well as the threshold throttle position voltage 135 are set by the user through the active AFR interface 140 installed on a computer 145. The user also sets a safe lower AFR value 150 and a safe upper AFR value 155 which are stored in the active wide-band air fuel ratio indicator 105. Only when both the engine RPM voltage 120 is greater than the threshold engine RPM voltage 135 and the throttle position voltage 125 is greater than the threshold throttle position voltage 130, will the LEDS 160, the audible component 165, and the active component trigger 170 of the active wide-band air fuel ratio indicator 105 be engaged after approximately a half second delay. Incorporating the delay allows for the meaningful operation of the LEDS 160, the audible component 165, and the active component trigger 170.

In some embodiments, when the LEDS 160, the audible component 165, and the active component trigger 170 are engaged, if the measured AFR value is less than the safe lower AFR value 150, then a yellow LED 160a will light and a piezo 165a will sound indicting a “rich” condition where there is too much fuel in the combustion chambers of the engine. During the “rich” condition, excessive fuel is deposited on the cylinder walls of the piston chamber. The excess fuel ends up “washing” away the oil needed to prevent cylinder wall damage. If the measured AFR value is greater than the safe upper AFR value 155, then a red LED 160b will light and the piezo 165a will sound indicting a “lean” condition where there is not enough fuel in the combustion chambers of the engine. During the “lean” condition, excessive heat is created in the piston chamber which may cause the piston to fail, such as the melting of the piston.

In some embodiments, the audible component 165 may comprise a device configured to transmit the warning to the vehicle sound system 195. In such a system, when the measured AFR ratio is out of range, the audible warning will be heard by driving the speakers of the vehicle. The signal may be transmitted from the audible component 165 to the vehicle sound system 195 via a wire or wirelessly.

In some embodiments, the active wide-band air fuel ratio indicator 105 further comprises a four digit, seven segment display 175 that continuously displays the measured AFR. When the AFR either goes below the safe lower AFR value 150 or above the safe upper AFR value 155, then the display 175 will no longer be updated and instead will show the exceeded AFR value. Additionally, when the AFR safe limits are exceeded, the active wide-band air fuel ratio indicator 105 will store the exceeded AFR values 180 which the user may download and graph via the user interface at a later time.

In some embodiments, if the user enables the operation of the active component 185, measures will be automatically taken to rectify the “lean” condition to protect the engine. The user has the option of enabling the active component 185 as well as defining a time delay 190 before the active component trigger 170 is engaged during a “lean” condition. Once the active component trigger 170 is engaged, it will remain engaged until the throttle position voltage 125 drops below the threshold throttle position voltage 135.

In some embodiments, the measures taken to rectify the “lean” condition may include misting water 170a or another coolant into the throttle body of the engine to cool the cylinders and/or diverting air 170b away from the throttle body using a valve. Misting water in the throttle body of the engine entails using a water pump with a nozzle connected to the throttle body piping to mist water into the air delivery system of the engine. The system uses a water reservoir that is plumbed to the pump with a normally closed solenoid between the pump and the nozzle that connects to the throttle piping. Diverting air away from the throttle body is accomplished by triggering an electronic solenoid. The electronic solenoid has tubing between the solenoid and the throttle body and/or throttle body piping. The tubing is connected to the throttle body and/or piping after the throttle body butterfly valve and either an electronic normally closed solenoid that opens to the atmosphere allowing air to be diverted away from the engine combustion chambers or an electronically normally open solenoid that connects between the throttle body and/or piping and an existing atmosphere blow-off valve. When the normally open solenoid is closed, it causes the existing blow-off valve to open, thus letting air within the throttle body piping to vent to the atmosphere.

In some embodiments, the apparatus may be a windshield, headliner, dashboard, rear view mirror, or post mounted indicator with the LEDs designed to illuminate the windshield or some other light guiding material, such as glass rods. Depending on the wide-band air fuel ratio, a red color may indicate a lean condition, a yellow color may indicate a rich condition, and if included, a green color may indicate an optimum condition. By illuminating the windshield or other light guiding material, the user does not have to look away from the road to monitor the engine air fuel ratio conditions.

In some embodiments, when outside of preset limits, the LEDs and audible warning may be accompanied with a voice which will say what limit has been exceeded and whether/what action was taken to remedy the issue. For example, “warning, the AFR ratio has gone outside of the acceptable range” and “warning, measures are being taken to bring AFR ratio back within an acceptable limit.”

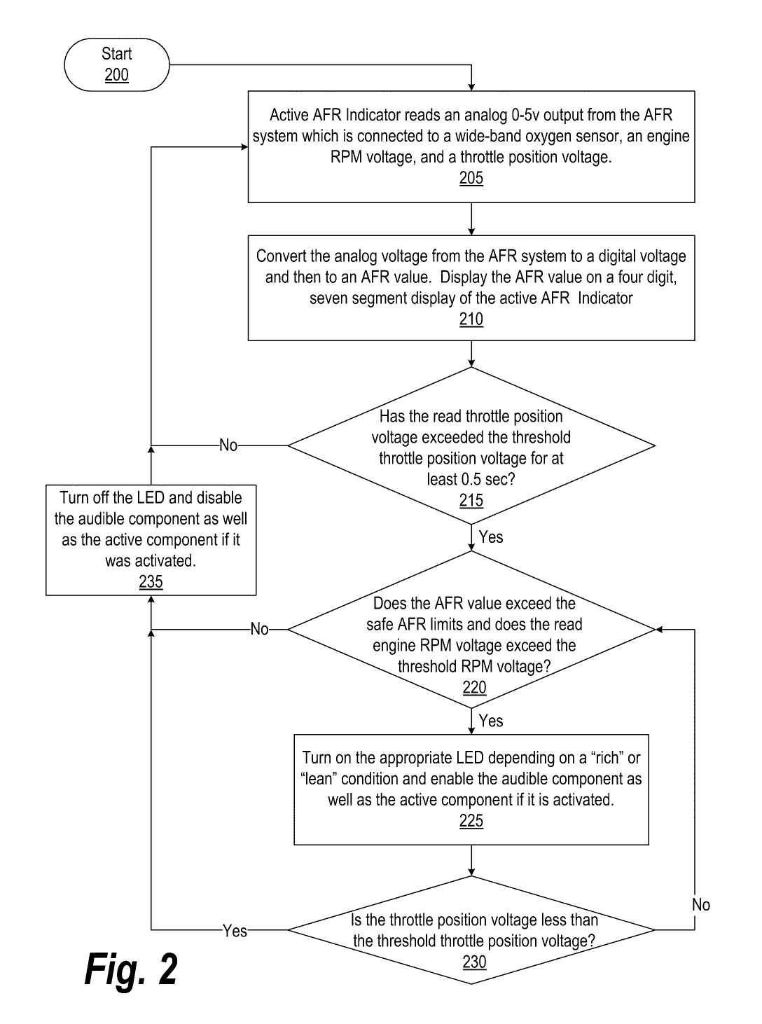

FIG. 2 is a flow diagram illustrating a method for actively monitoring an air fuel ratio, in accordance with some embodiments.

Processing begins at 200 whereupon, at block 205, an analog 0-5v output from the AFR system which is connected to a wide-band oxygen sensor, an engine RPM voltage, and a throttle position voltage are all read by the active AFR indicator. The active AFR indicator has set values for the threshold RPM voltage, the threshold throttle position voltage, the safe lower AFR, the safe upper AFR, the logic state for enabling the active component, and the time delay before the active component is triggered.

At block 210, the voltage read from the AFR system is converted to a digital voltage and then to an AFR value. The AFR value is then displayed on a four digit, seven segment display of the active AFR indicator.

At decision 215, a determination is made as to whether the read throttle position voltage exceeds the threshold throttle position voltage for at least 0.5 seconds. The time delay is incorporated so that the active AFR indicator would not continuously sound the audible component for only a brief surpassing of the threshold throttle position voltage. If the threshold throttle position voltage has not been exceeded for at least 0.5 seconds, processing loops back to block 205. If the threshold throttle position voltage has been exceeded for at least 0.5 seconds, processing continues to decision 220.

At decision 220, a determination is made as to whether the read AFR is less than the safe lower AFR or greater than the safe upper AFR. A determination is also made as to whether the read engine RPM voltage exceeds the threshold RPM voltage. If the read AFR exceeds the safe AFR limits and the read engine RPM voltage exceeds the threshold RPM voltage, then processing continues to block 225. If either one of the parameters, AFR limits or RPM voltage, are not exceeded, then processing loops back to block 205. Before looping back to block 205, at block 235, the LED is turned off and the audible component as well as the active component are disabled if they had been turned on and enabled prior.

At block 225, the appropriate LED, depending on whether a “rich” or “lean” condition has been met, is turned on. The audible component is also triggered as well as the active component depending on the logic state for enabling the active component.

At decision 230, a determination is made as to whether the throttle position voltage is less than the threshold throttle position voltage. If the throttle position voltage is less than the threshold throttle position voltage, then processing proceeds to block 235 before looping back to block 205. If the throttle position voltage is not less than the threshold throttle position voltage, processing loops back to decision 220.

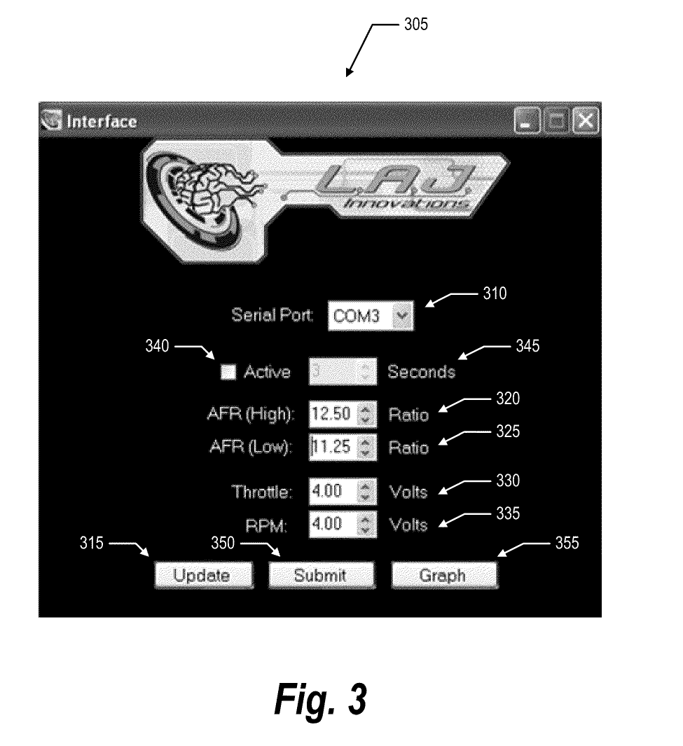

FIG. 3 is a graphical user interface for the air fuel ratio indicator, in accordance with some embodiments.

In some embodiments, a graphical user interface (GUI) 305 from software installed onto a computer is used to set certain parameters of the active wide-band air fuel ratio indicator 105. The user first selects which serial port the active wide-band air fuel ratio indicator 105 is connected to by selecting the appropriate serial port from the serial port drop down menu 310. If the user selects the Update button 315 of the GUI, values for the safe upper AFR value 320, the safe lower AFR value 325, the threshold throttle position voltage 330, and the threshold engine RPM voltage 335, are read from the active wide-band air fuel ratio indicator 105 and displayed on the GUI 305. The field for whether the active component 185 is enabled 340 will also be updated as well as the value of any time delay 345 before any active measures to correct a “lean” condition are triggered. The user also has the option of setting the safe upper AFR value 320, the safe lower AFR value 325, the threshold throttle position voltage 330, the threshold engine RPM voltage 335, the Active field 340, and the time delay field 345 and then selecting the Submit button 350 to write the set values to the active wide-band air fuel ratio indicator 105. Finally the user also has the option of graphing the values of the AFR for occurrences when the AFR exceeded the threshold limits 320 and 325, the threshold throttle voltage 330, and the threshold engine RPM voltage 335 by selecting the Graph button 355 which downloads these AFR values from the active wide-band air fuel ratio indicator 105 and graphs them on the computer.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. An apparatus for protecting an engine of a vehicle, the apparatus comprising:
one or more processors;
one or more memory units coupled to the one or more processors; and
a visual indicator coupled to the one or more processors;
the apparatus being configured to:
read a throttle position voltage, an engine RPM voltage, and a voltage from an air fuel ratio (AFR) system comprising a wide-band oxygen sensor;
convert the voltage from the AFR system to an AFR value;
determine whether the throttle position voltage exceeds a preset threshold throttle position voltage;
in response to determining that the throttle position voltage exceeds the preset threshold throttle position voltage, determine whether the AFR value exceeds a preset safe lower AFR limit or a preset safe upper AFR limit and whether the engine RPM voltage exceeds a preset threshold RPM voltage;
in response to determining that the AFR value exceeds the preset safe lower AFR limit or the preset safe upper AFR limit and the engine RPM voltage exceeds the preset threshold RPM voltage, turn on the visual indicator.

2. The apparatus of claim 1, wherein the apparatus further comprises:
an active component coupled to the one or more processors;
the apparatus being further configured to: in response to determining that the AFR value exceeds the preset safe lower AFR limit or the preset safe upper AFR limit and the engine RPM voltage exceeds the preset threshold RPM voltage, turn on an audible indicator.

3. The apparatus of claim 1, wherein the apparatus further comprises:
an audible indicator coupled to the one or more processors;
the apparatus being further configured to: in response to determining that the AFR value exceeds the preset safe upper AFR limit and the engine RPM voltage exceeds the preset threshold RPM voltage, trigger an active component configured to lower the AFR value below the preset safe upper AFR limit.

4. The apparatus of claim 3, wherein the apparatus being further configured to trigger the active component comprises at least one of: misting a coolant into the air delivery system of the engine, and allowing air to be diverted away from the combustion chambers of the engine.

5. The apparatus of claim 1, wherein the apparatus further comprises:
an audible indicator coupled to the one or more processors;
the apparatus being further configured to: in response to determining that the AFR value exceeds the preset safe upper AFR limit and the engine RPM voltage exceeds the preset threshold RPM voltage, trigger an active component configured to lower the AFR value below the preset safe upper AFR limit after a preset time delay.

6. The apparatus of claim 1, wherein the apparatus further comprises:
a display unit coupled to the one or more processors, the display unit being configured to show the AFR value.

7. The apparatus of claim 1, wherein the apparatus being further configured to determine whether the throttle position voltage exceeds the preset threshold throttle position voltage for longer than a preset time.

8. The apparatus of claim 5, wherein the apparatus being further configured to interface to a computer graphical user interface to enable reading and writing the preset threshold throttle position voltage, the preset threshold RPM voltage, the preset safe lower AFR limit, the preset safe upper AFR limit, and the preset time delay.

9. The apparatus of claim 1, wherein the visual indicator comprises at least one of: an LED, a lamp, and a light guide.

10. The apparatus of claim 2, wherein the audible indicator comprises at least one of: a piezo, and a speaker.

11. A method for protecting an engine of a vehicle, the method comprising:
reading a throttle position voltage, an engine RPM voltage, and a voltage from an air fuel ratio (AFR) system comprising a wide-band oxygen sensor;
converting the voltage from the AFR system to an AFR value;
determining whether the throttle position voltage exceeds a preset threshold throttle position voltage;
in response to determining that the throttle position voltage exceeds the preset threshold throttle position voltage, determining whether the AFR value exceeds a preset safe lower AFR limit or a preset safe upper AFR limit and whether the engine RPM voltage exceeds a preset threshold RPM voltage;
in response to determining that the AFR value exceeds the preset safe lower AFR limit or the preset safe upper AFR limit and the engine RPM voltage exceeds the preset threshold RPM voltage, turning on a visual indicator.

12. The method of claim 11, wherein in response to determining that the AFR value exceeds the preset safe lower AFR limit or the preset safe upper AFR limit and the engine RPM voltage exceeds the preset threshold RPM voltage, further comprising turning on an audible indicator.

13. The method of claim 11, wherein in response to determining that the AFR value exceeds the preset safe upper AFR limit and the engine RPM voltage exceeds the preset threshold RPM voltage, further comprising triggering an active component configured to lower the AFR value below the preset safe upper AFR limit.

14. The method of claim 13, wherein triggering the active component comprises at least one of: misting a coolant into the air delivery system of the engine, and allowing air to be diverted away from the combustion chambers of the engine.

15. The method of claim 11, wherein in response to determining that the AFR value exceeds the preset safe upper AFR limit and the engine RPM voltage exceeds the preset threshold RPM voltage, further comprising triggering an active component configured to lower the AFR value below the preset safe upper AFR limit after a preset time delay.

16. The method of claim 11, the method further comprising displaying the AFR value.

17. The method of claim 11, wherein in determining whether the throttle position voltage exceeds the preset threshold throttle position voltage, the determination further comprises determining whether the throttle position voltage exceeds the preset threshold throttle position voltage for longer than a preset time.

18. The method of claim 15, the method further comprising interfacing to a computer graphical user interface to enable reading and writing the preset threshold throttle position voltage, the preset threshold RPM voltage, the preset safe lower AFR limit, the preset safe upper AFR limit, and the preset time delay.

19. The method of claim 11, wherein turning on a visual indicator comprises at least one of: turning on an LED, turning on a lamp, and illuminating a light guide.

20. The method of claim 12, wherein turning on an audible indicator comprises at least one of: turning on a piezo, and driving a speaker.
